(19) United States
(12) Patent Application Publication
(10) Pub. No.: US 2024/0053962 A1
(43) Pub. Date: Feb. 15, 2024

(54) Absolute Difference Circuitry with Parallel Comparison Logic

(71) Applicant: Apple Inc., Cupertino, CA (US)

(72) Inventors: Michael L. Liu, Palo Alto, CA (US); Yash H. Malviya, San Jose, CA (US)

(21) Appl. No.: 17/885,364

(22) Filed: Aug. 10, 2022

(51) Int. Cl. G06F 7/50; G06F 7/02

(52) U.S. Cl. CPC G06F 7/50; G06F 7/02

(57) ABSTRACT

An integrated circuit can include absolute difference circuitry configured to compute an absolute difference value. The absolute difference circuitry may include a comparison logic, a single adder, and a multiplexer. The comparison logic may receive a first input value and a second input value and may generate a comparison value based on whether the first input value exceeds the second input value. The adder may compute a sum of the first input value, an inverted version of the second input value, and the comparison value. The multiplexer may receive the sum and an inverted version of the sum and may output either the sum or the inverted version of the sum based on the comparison value to produce the absolute difference value.

### FIELD

Embodiments described herein relate generally to integrated circuits and, more particularly, to integrated circuits with a difference circuit.

### BACKGROUND

Integrated circuits often include difference circuits. A type of difference circuit that calculates an unsigned absolute value of the difference of two signed input numbers can be referred to as an absolute difference circuit. Absolute difference circuits are commonly used in many signal processing and data compute blocks.

It can be challenging to design an absolute difference circuit to optimize for both power and area without compromising on the performance. Conventional absolute difference circuits can be fast but consume too much area/power or can be made to consume less area/power but are too slow. It is within this context that the embodiments herein arise.

### SUMMARY

An electronic device may include an integrated circuit having absolute difference circuitry. The absolute difference circuitry may receive a first input number and a second input number and may compute a corresponding absolute difference value, which can be defined as the absolute value of the difference between the first input number and the second input number. The first and second input numbers can be signed numbers. The absolute difference circuitry can include only one adder block, a comparison logic block, one or more inverting blocks, and a selection block. The comparison logic block may compare the first input number with the second input number to determine whether the first input number is greater than or equal to the second input number and may generate a corresponding comparison output value. The adder block may receive the first and second input numbers and the comparison output value and may compute a sum. The selection block can receive the sum and an inverted version of the sum and may pass either the received sum or the inverted version of the sum to its output depending on the comparison output value. The output of the selection block operated in this way is equal to the absolute difference value.

An aspect of the disclosure provides absolute difference circuitry that includes: a comparison logic circuit having a first input configured to receive a first input value, a second input configured to receive a second input value, and an output on which a corresponding comparison value is generated; and an adder circuit having a first input configured to receive the first input value, a second input configured to receive the second input value, a third input configured to receive the comparison value from the output of the comparison logic circuit, and an output on which an adder output value is generated. The adder circuit can be configured to compute the adder output value based on a sum of the first input value, an (inverted) version of the second input value different than the second input value, and the comparison value. The comparison logic circuit can drive the comparison value to a logic one upon determining that the first input value is greater than or equal to the second input value and can drive the comparison value to a logic zero upon determining that the first input value is less than the second input value. The absolute difference circuitry can further include a selection circuit having a first input configured to receive the adder output value directly from the output of the adder circuit, a second input configured to receive an inverted version of the adder output value via an inverter, and a third input configured to receive the comparison value.

An aspect of the disclosure provides a method of operating absolute difference circuitry to compute an absolute difference value. The method can include: comparing a first input value to a second input value to obtain a comparison value; computing a sum of the first input value, a version of the second input value different than the second input value, and the comparison value; and selecting between the sum and an (inverted) version of the sum. The method can include determining whether the first input value is greater than or equal to the second input value. The method can include asserting the comparison value in response to determining that the first input value is greater than or equal to the second input value, and deasserting the comparison value in response to determining that the first input value is less than the second input value. The sum can be computed by adding the first input value, an inverted version of the second input value, and the comparison value. The sum can be selected as the final output when the comparison value is high, whereas the inverted version of the sum can be selected as the final output when the comparison value is low.

An aspect of the disclosure provides absolute difference circuitry that includes: a comparison logic configured to receive first and second input numbers and to generate a comparison output based on a comparison of the first and second input numbers; an adder configured to receive the first and second input numbers and the comparison output and to generate an adder output; a multiplexer configured to receive the adder output, a version of the adder output different than the adder output, and the comparison output. The adder generates the adder output by computing a sum of the first input number, an inverted version of the second input number, and the comparison output. The multiplexer can receive the adder output, an inverted version of the adder output, and the comparison output and can output either the adder output or the inverted version of the adder output based on the comparison output.

Further features of the invention, its nature and various advantages will be more apparent from the accompanying drawings and following detailed description.

### BRIEF DESCRIPTION OF THE DRAWINGS

FIG. 1 is a diagram of an illustrative integrated circuit having absolute difference circuitry in accordance with some embodiments.

FIG. 2 is a block diagram of illustrative absolute difference circuitry in accordance with some embodiments.

FIG. 3 is a circuit diagram showing an illustrative implementation of absolute difference circuitry of the type shown in FIG. 2 in accordance with some embodiments.

FIG. 4 is a flow chart of illustrative operations for controlling absolute difference circuitry of the type described in connection with FIGS. 1-3 in accordance with some embodiments.

### DETAILED DESCRIPTION

This relates to an integrated circuit having absolute difference circuitry. Such integrated circuit can be part of any type of electronic device or system(s), including but not limited to a cellular telephone, a tablet computer, a wristwatch, a laptop computer, a desktop computer, a monitor, a display with one or more displays, a media player, a digital content streaming device, a charger, an earbud, a headphone, a speaker, a stylus, a keyboard, an accessory, a wearable device, a head-mounted device, an automobile, or other electronic systems. The absolute difference circuitry can be used to generate an absolute difference value for a wide range of electronic applications.

The absolute difference circuitry can include a single adder block, a comparison block, and a multiplexing block. The comparison block may determine whether a first input value is greater than or equal to a second input value. The comparison block may output a logic “1” upon determining that the first input value is greater than or equal to the second input value or may output a logic “0” upon determining that the first input value is less than the second input value. The adder block may receive the first input value, the second input value, and the comparison output from the comparison block. A portion of the adder operation at the adder block and a portion of the comparison operation at the comparison block can occur in parallel to minimize the overall delay. The adder block may compute an adder output that is equal to the sum of the first input value, an inverted version of the second input value, and the comparison output.

The multiplexing block has a first input that receives the adder output, a second input that receives an inverted version of the adder output, a control input that receives the comparison output, and an output on which an absolute value of the difference of the first and second input values is generated (sometimes referred to as the absolute difference value). Configured and operated in this way, the absolute difference circuitry exhibits minimal area and power consumption without degrading performance.

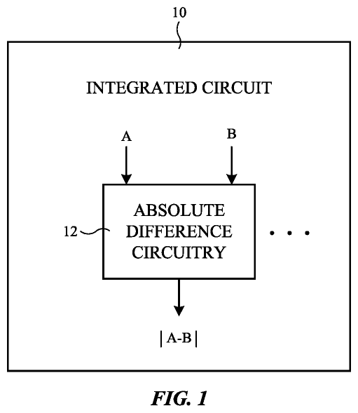

FIG. 1 is a diagram of an illustrative integrated circuit device such as integrated circuit 10 having absolute difference circuitry 12. Integrated circuit 10 can represent one or more processors such as a microprocessor, a microcontroller, a digital signal processor, an image signal processor, a host processor, a baseband processor, an application processor, a central processing unit (CPU), a graphics processing unit (GPU), a power management integrated circuit (PMIC), a field-programmable gate array or programmable logic device, a sound (audio) chip, a wireless communications processor such as a radio-frequency transceiver chip, an artificial intelligence or machine learning processor, a combination of these circuits, or other types of integrated circuits.

Absolute difference circuitry 12 may have a first input port configured to receive a first signed input A and may have a second input port configured to receive a second signed input B. Inputs A and B received at the input ports of absolute difference circuitry 12 can be referred to as input numbers or input values. Absolute difference circuitry 12 can be configured to compute or calculate an unsigned absolute value of the difference between inputs A and B. In other words, absolute difference circuitry 12 may generate at its output port an absolute difference value equal to the magnitude |A−B|, which is always a positive output value. The term “absolute” value can be defined as an unsigned value, which is always positive. In general, integrated circuit device 10 may include multiple instances of absolute difference circuitry 12 for computing a large number of absolute difference values in a sequential or parallel manner.

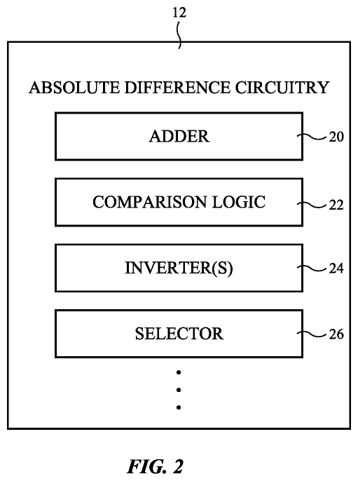

FIG. 2 is a block diagram of illustrative absolute difference circuitry 12. As shown in FIG. 2, absolute difference circuitry 12 may include an adder circuit such as adder 20, a comparison circuit such as comparison logic 22, one or more inverting circuits such as inverter(s) 24, and a selection circuit such as selector 26. Absolute difference circuitry 12 may include only one adder 20. Compared to conventional absolute difference circuits that employ two or more adders, absolute difference circuitry 12 that uses only one adder 20 exhibits substantially reduced area and power consumption.

Adder circuit 20 can be implemented using any digital adder architecture. For example, adder 20 can be implemented as a carry-lookahead adder, a ripple-carry adder, a carry-select adder, a square-root carry-select adder, a carry-save adder, a carry-bypass adder, a combination of these adder topologies, and/or other types of adders. In certain embodiments, adder 20 may include adder components (e.g., propagate and carry generation components) configured in a tree-like structure. As examples, adder 20 can be implemented as a Brent-Kung adder, Kogge-Stone adder, Han-Carlson adder, Lynch-Swartzlander adder, or other parallel prefix adders.

Comparison logic 22 may be a digital comparison logic circuit for comparing two input values. Comparison logic 22 may assert its output (e.g., drive its output high) in response to detecting that a first input value is greater than or equal to a second input value and may deassert its output (e.g., drive its output low) in response to detecting that the first input value is less than the second input value. Inverter(s) 24 can be used to invert the bits of a signal to generate a corresponding inverted version of the signal. Selector 26 can be used to select between two signals. Selector 26 may, for example, be a multiplexing circuit configured to receive a plurality of input signals and a control signal and to output a selected one of the plurality of input signals based on a value of the control signal.

The example of FIG. 2 in which absolute difference circuitry 12 includes circuits 20, 22, 24, and 26 is illustrative and not intended to limit the scope of the present embodiments. If desired, absolute difference circuitry 12 can include addition circuit components (not shown). If desired, one or more of circuits 20, 22, 24, and 26 can be omitted from circuitry 12 and shifted as part of other processing circuitry within integrated circuit device 10. For example, selector 26 might be offloaded onto another processing block within device 10. As another example, comparison logic might be offloaded onto another processing block within device 10.

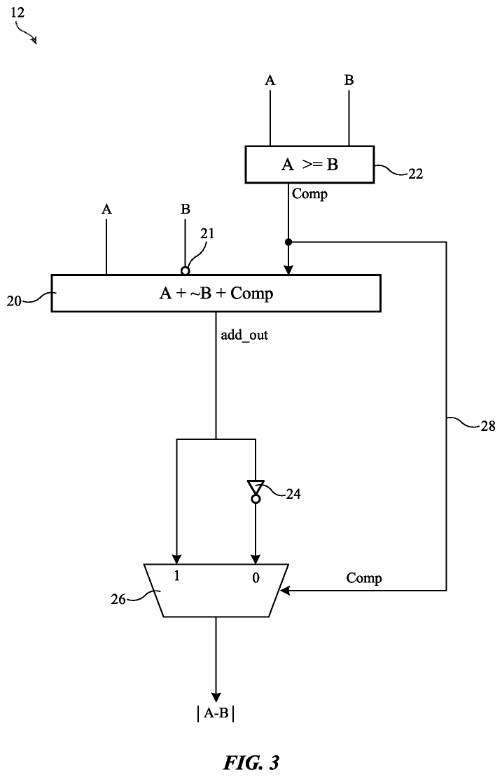

FIG. 3 is a circuit diagram showing an illustrative implementation of absolute difference circuitry 12. As shown in FIG. 3, absolute difference circuitry 12 may receive a first input value A and a second input value B. Input values A and B can be signed input numbers. If desired, input values A and B can also be unsigned input numbers.

Comparison logic 22 has a first input configured to receive input value A, a second input configured to receive input value B, and an output on which a corresponding comparison result Comp is provided. Comparison logic 22 may determine whether input value A is greater than or equal to input value B. In general, any type of digital comparison logic circuit can be implemented for logic 22. If comparison logic 22 determines that input value A is greater than or equal to input value B, then comparison logic 22 may assert its output (e.g., by driving comparison output Comp to a logic “1”). If comparison logic 22 determines that input value A is less than input value B, then comparison logic 22 may deassert its output (e.g., by driving comparison output Comp to a logic “0”). Comparison output value Comp can be fed as an input to adder 20 and as a control input to selector 26.

Adder 20 may have a first input configured to receive input value A, a second input configured to receive input value B, a third input configured to receive signal Comp from the output of comparison logic 22, and an output on which a corresponding sum signal (value) add_out is generated. Adder 20 may be configured to compute a sum of input value A, an inverted version of input value B (sometimes referred to as “not B”), and the comparison logic output value Comp (e.g., adder output value add_out=A+˜B+Comp). The inverted version of input value B may be calculated using an inverted input (as indicated by inversion 21 at the second input of adder 20) or otherwise using one or more inverting circuits 24 (see FIG. 2) to invert all of the bits of B (e.g., to flip all of the logic “1's” to logic “0's” and to flip all of the logic “0's” to logic “1's”).

Selector 26 may be implemented as a multiplexing circuit such as a 2:1 multiplexer. Multiplexer 26 may have a first (1) input configured to receive signal (value) add_out directly from the output of adder 20, a second (0) input configured to receive an inverted version of signal add_out via an inverter 24, a control input configured to receive signal Comp from the output of comparison logic 22 via a feedforward path 28, and an output on which the final absolute difference value |A−B| is computed. Inverter 24 may invert all of the bits in signal add_out (e.g., to flip all of the logic “1's” to logic “0's” and to flip all of the logic “0's” to logic “1's”).

The following description explains how absolute difference circuitry 12 can generate the desired absolute difference value |A−B|. By definition, negative X can be defined as an inverted version of X (i.e., ˜X or “not X”) plus one. This is similar to the definition of the two's complement. By adding “1” to both sides of this equation, ˜X is therefore equal to (—X−1).

Adder 20 may compute different values depending on whether input value A is greater than or less than input value B. When input value A is greater than or equal to input value B, the comparison result Comp will be equal to “1”. Thus, adder 20 will compute the sum of A, ˜B, and 1. According to the definition of an inverted term defined above, the second adder term ˜B is equal to (—B−1). As a result, the −1 and +1 will cancel out, and the final sum will be equal to (A−B). Since A has already been determined to be greater than or equal to B, (A−B) will be a positive value or at least equal to zero. This difference value is provided as the first input to multiplexer 26. Multiplexer 26 will output this value (i.e., A−B) when signal Comp is asserted (e.g., in response to determining that A>=B).

When input value A is less than input value B, the comparison result Comp will be equal to “0”. Thus, adder 20 will compute the sum of A, ˜B, and 0. Inverter 24 will then invert this sum to output ˜(A+˜B). According to the definition of an inverted term defined above, ˜(A+˜B) is equal to (−(A+˜SB)−1). Further substituting the ˜B term by (−B−1) will produce (−(A+(−B−1))−1) at the output of inverter 24. As a result, the +1 and −1 will cancel out, and the final sum will be equal to (B−A). Since A has already been determined to be less than B, (B−A) will be a positive value. This difference value is provided as the second input to multiplexer 26. Multiplexer 26 will output this value (i.e., B−A) when signal Comp is deasserted (e.g., in response to determining that A<B).

Configured and operated in this way, comparator 22 effectively performs a pre-emptive determination on whether an increment operation (e.g., the +1 at the third input of adder 20) is needed while calculating (A+˜B). This obviates the need for a separate increment block and thus merges all addition operations into the single adder block 20. Part of the computation at adder 20 and part of the computation at comparison logic 22 can occur in parallel. This is possible because the output of comparison logic 22 is not immediately required (e.g., adder 20 has at least a couple of gate delays used for calculating ˜B and the sum of A and ˜B before using the +1 input). The use of only a single adder block (tree) along with the parallel computation of adder 20 and comparison logic 22, where the output of comparison logic 22 is fed as an input to adder 20 and selector 26, produces an absolute difference circuit exhibiting substantially power and area savings while still being able to function at target operating frequencies.

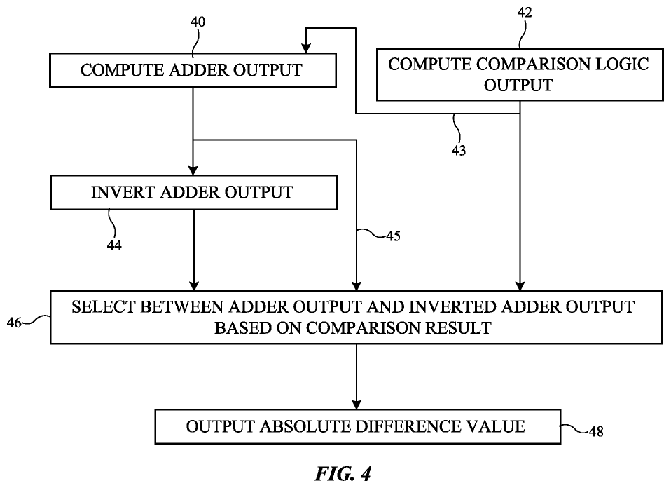

FIG. 4 is a flow chart of illustrative operations for controlling absolute difference circuitry 12 of the type described in connection with FIGS. 1-3. During the operations of block 40, an adder (e.g., adder 20 of FIG. 3) may compute an adder output. For example, the adder may compute an adder output value that is equal to (A+˜B+Comp), where Comp is the output of comparison logic 22.

At least partially concurrent with the operations of block 40, a comparison logic (e.g., comparison logic 22 of FIG. 3) may compute a comparison output value. The comparison logic may compare A and B to determine which input is the greater number. Upon a determination that A is the greater number, the comparison logic may drive the comparison output value high. Upon a determination that B is the greater number, the comparison logic may drive the comparison output value low. The comparison output value may be fed as an input to the adder, as shown by path 43, and to a selector (e.g., selector 26 of FIG. 3).

During the operations of block 44, an inverter may invert the adder output (e.g., inverter 24 may invert signal add_out in FIG. 3).

During the operations of block 46, the selector may receive the adder output directly from the adder (as shown by path 45), may receive an inverted adder output from the inverter, and may select between the two inputs depending on the comparison output. If the comparison output value is high, then the selector will pass the non-inverted adder output value to its output. If the comparison output value is low, then the selector will pass the inverted adder output value to its output.

The non-inverted adder output value may be equal to (A−B) assuming A is greater than or equal to B. The inverted adder output value may be equal to (B−A) assuming A is less than B. As a result, the value generated at the output of the selector will be the absolute difference value of A and B, which is provided at step 48.

The operations of FIG. 4 are illustrative. At least some of the described operations may be modified or omitted; some of the described operations may be performed in parallel; additional processes may be added or inserted between the described operations; the order of certain operations may be reversed or altered; and/or the timing of the described operations may be adjusted so that they occur at slightly different times. For example, the operations of blocks 40 and 42 can be performed simultaneously or can be partially concurrent. As another example, the operations of block 42 can be performed prior to the operations of block 40. As another example, the operations of block 40 can be performed prior to the operations of block 42. As another example, at least some of the operations of block 22 can be offloaded to another circuit block external to absolute difference circuitry 12. As another example, at least some of the operations of block 46 can be offloaded to another circuit block external to absolute difference circuitry 12.

The foregoing is merely illustrative and various modifications can be made to the described embodiments. The foregoing embodiments may be implemented individually or in any combination.

What is claimed is:

1. Circuitry comprising:
a comparison circuit having a first input configured to receive a first input value, a second input configured to receive a second input value, and an output on which a corresponding comparison value is generated; and
an adder circuit having a first input configured to receive the first input value, a second input configured to receive the second input value, a third input configured to receive the comparison value from the output of the comparison circuit, and an output on which an adder output value is generated, wherein the adder circuit is configured to compute the adder output value based on a sum of the first input value and the comparison value.

2. The circuitry of claim 1, wherein the adder circuit is configured to compute the adder output value based on a sum of the first input value, a version of the second input value different than the second input value, and the comparison value.

3. The circuitry of claim 1, wherein the adder circuit is configured to compute the adder output value based on a sum of the first input value, an inverted version of the second input value, and the comparison value.

4. The circuitry of claim 1, wherein the second input of the adder circuit is an inverting input configured to invert bits of the second input value.

5. The circuitry of claim 1, wherein the comparison circuit is configured to:
drive the comparison value to a first value upon determining that the first input value is greater than or equal to the second input value; and
drive the comparison value to a second value different than the first value upon determining that the first input value is less than the second input value.

6. The circuitry of claim 1, wherein the comparison circuit is configured to:
drive the comparison value high upon determining that the first input value is greater than or equal to the second input value; and
drive the comparison value low upon determining that the first input value is less than the second input value.

7. The circuitry of claim 1, further comprising:
an inverter configured to receive the adder output value.

8. The circuitry of claim 1, further comprising:
a selection circuit having a first input configured to receive the adder output value directly from the output of the adder circuit, a second input configured to receive a version of the adder output value different than the adder output value, and a third input configured to receive the comparison value from the output of the comparison circuit.

9. The circuitry of claim 1, further comprising:
a selection circuit having a first input configured to receive the adder output value directly from the output of the adder circuit, a second input configured to receive an inverted version of the adder output value via an inverter, and a third input configured to receive the comparison value from the output of the comparison circuit.

10. The circuitry of claim 9, wherein the selection circuit has an output on which an absolute value of a difference between the first and second input values is generated.

11. A method comprising:
comparing a first input value to a second input value to obtain a comparison value;
computing a sum of the first input value, a version of the second input value different than the second input value, and the comparison value; and
selecting between the sum and a version of the sum different than the sum.

12. The method of claim 11, wherein comparing the first input value to the second input value comprises determining whether the first input value is greater than or equal to the second input value.

13. The method of claim 12, wherein comparing the first input value to the second input value comprises further comprises:
asserting the comparison value in response to determining that the first input value is greater than or equal to the second input value; and
deasserting the comparison value in response to determining that the first input value is less than the second input value.

14. The method of claim 11, wherein computing the sum comprises calculating a sum of the first input value, an inverted version of the second input value, and the comparison value.

15. The method of claim 11, wherein selecting between the sum and a version of the sum different than the sum comprises selecting between the sum and an inverted version of the sum.

16. The method of claim 11, wherein selecting between the sum and a version of the sum different than the sum comprises:
selecting the sum upon determining that the comparison value is high; and
selecting a version of the sum different than then sum upon determining that the comparison value is low.

17. Absolute difference circuitry comprising:
a comparison logic configured to receive first and second input numbers and to generate a comparison output based on a comparison of the first and second input numbers;
an adder configured to receive the first and second input numbers and the comparison output and to generate an adder output; and
a multiplexer configured to receive the adder output, a version of the adder output different than the adder output, and the comparison output.

18. The absolute difference circuitry of claim 17, wherein the adder is configured to generate the adder output by computing a sum of the first input number, an inverted version of the second input number, and the comparison output.

19. The absolute difference circuitry of claim 17, wherein the multiplexer is configured to:
receive the adder output, an inverted version of the adder output, and the comparison output; and
output either the adder output or the inverted version of the adder output based on the comparison output.

20. The absolute difference circuitry of claim 17, wherein the adder is the only adder in the absolute difference circuitry.
